(19) United States
(12) Patent Application Publication
(10) Pub. No.: US 2006/0153295 A1
(43) Pub. Date: Jul. 13, 2006

(54) Method and system for inter-layer prediction mode coding in scalable video coding

(75) Inventors: Xianglin Wang, Irving, TX (US); Yiliang Bao, Coppell, TX (US); Marta Karczewicz, Irving, TX (US); Justin Ridge, Sachse, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/331,433

(22) Filed: Jan. 11, 2006

Related U.S. Application Data
(60) Provisional application No. 60/643,455, filed on Jan. 12, 2005.
(60) Provisional application No. 60/643,847, filed on Jan. 14, 2005.

(51) Int. Cl. H04N 7/12; H04N 11/04; H04B 1/66; H04N 11/02

(52) U.S. Cl. 375/240.08; 375/240.24; 375/240.12

(57) ABSTRACT

The present invention improves residue prediction by using MI even when the base layer MB is encoded in intra mode such as copying intra 4×4 mode of one 4×4 block in the base layer to multiple neighboring 4×4 blocks in the enhancement layer if the base layer resolution is lower than the enhancement layer resolution, using the intra 4×4 mode as intra 8×8 mode if the base layer resolution is lower than the enhancement layer resolution and the base layer resolution is half of the enhancement layer resolution in both dimensions, carrying out direct calculation of the base layer prediction residue used in RP, clipping of prediction residue for reducing memory requirement and tunneling of prediction residue in BLTP mode; and conditional coding of RP flag to save flag bits and reduce implementation complexity

This patent application is based on and claims priority to U.S. Provisional Patent Application No. 60/643,455, filed Jan. 12, 2005 and U.S. Provisional Patent Application No. 60/643,847, filed Jan. 14, 2005.

### FIELD OF THE INVENTION

The present invention relates to the field of video coding and, more specifically, to scalable video coding.

### BACKGROUND OF THE INVENTION

In a typical single layer video scheme, such as H0.264, a video frame is processed in macroblocks. If the macroblock (MB) is an inter-MB, the pixels in one macroblock can be predicted from the pixels in one or multiple reference frames. If the macroblock is an intra-MB, the pixels in the MB in the current frame can also be predicted entirely from the pixels in the same video frame.

For both inter-MB and intra-MB, the MB is decoded in the following steps:
Decode the syntax elements of the MB, syntax elements including prediction modes and associated parameters;
Based on syntax elements, retrieve the pixel predictors for each partition of MB. An MB can have multiple partitions, and each partition can have its own mode information;
Perform entropy decoding to obtain the quantized coefficients;
Perform inverse transform on the quantized coefficients to reconstruct the prediction residue; and
Add pixel predictors to the reconstructed prediction residues in order to obtain the reconstructed pixel values of the MB.

At the encoder side, the prediction residues are the difference between the original pixels and their predictors. The residues are transformed and the transform coefficients are quantized. The quantized coefficients are then encoded using certain entropy-coding scheme.

If the MB is an inter-MB, it is necessary to code the information related to mode decision, such as:
MB type to indicate that this is an inter-MB;
Specific inter-frame prediction modes that are used. The prediction modes indicate how the MB is partitioned. For example, the MB can have only one partition of size 16×16, or two 16×8 partitions and each partition can have different motion information, and so on;
One or more reference frame indices to indicate the reference frames from which the pixel predictors are obtained. Different parts of an MB can have predictors from different reference frames;
One or more motion vectors to indicate the locations on the reference frames where the predictors are fetched.

If the MB is an intra-MB, it is necessary to code the information, such as:
MB type to indicate that this is an intra-MB;
Intra-frame prediction modes used for luma. If the luma signal is predicted using the intra 4×4 mode, then each 4×4 block in the 16×16 luma block can have its own prediction mode, and sixteen intra 4×4 modes are coded for an MB. If luma signal is predicted using the intra 16×16 mode, then only one intra 16×16 mode is associated with the entire MB;
Intra-frame prediction mode used for chroma.

In either case, there is a significant amount of bits spent on coding the modes and associated parameters.

In a scalable video coding solution as proposed in Scalable Video Model 3.0 (ISO/IEC JTC 1/SC 29/WG 11N6716, October 2004, Palma de Mallorca, Spain), a video sequence can be coded in multiple layers, and each layer is one representation of the video sequence at a certain spatial resolution or temporal resolution or at a certain quality level or some combination of the three. In order to achieve good coding efficiency, some new texture prediction modes and syntax prediction modes are used for reducing the redundancy among the layers.

Mode Inheritance from Base Layer (MI)

In this mode, no additional syntax elements need to be coded for an MB except the MI flag. MI flag is used for indicating that the mode decision of this MB can be derived from that of the corresponding MB in the base layer. If the resolution of the base layer is the same as that of the enhancement layer, all the mode information can be used as is. If the resolution of the base layer is different from that of the enhancement layer (for example, half of the resolution of the enhancement layer), the mode information used by the enhancement layer needs to be derived according to the resolution ratio.

Base Layer Texture Prediction (BLTP)

In this mode, the pixel predictors for the whole MB or part of the MB are from the co-located MB in the base layer. New syntax elements are needed to indicate such prediction. This is similar to inter-frame prediction, but no motion vector is needed as the locations of the predictors are known. This mode is illustrated in FIG. 1. In FIG. 1, C1 is the original MB in the enhancement layer coding, and B1 is the reconstructed MB in the base layer for the current frame used in predicting C1. In FIG. 1, the enhancement layer frame size is the same as that in the base layer. If the base layer is of a different size, proper scaling operation on the base layer reconstructed frame is needed.

Residue Prediction (RP)

In this mode, the reconstructed prediction residue of the base layer is used in reducing the amount of residue to be coded in the enhancement layer, when both MBs are encoded in inter mode.

In FIG. 1, the reconstructed prediction residue in the base layer for the block is (B1−B0). The best reference block in the enhancement layer is E0. The actual predictor used in predicting C1 is (E0+(B1−B0)). The actual predictor is referred to as the “residue-adjusted predictor”. If we calculate the prediction residue in the RP mode, we shall get
C1−(E0+(B1−B0))=(C1−E0)−(B1−B0).

If Residue Prediction is not used, the normal prediction residue of (C1−E0) in the enhancement layer is encoded. What is encoded in RP mode is the difference between the first order prediction residue in the enhancement layer and the first order prediction residue in the base layer. Hence this texture prediction mode is referred to as Residue Prediction. A flag is needed to indicate whether RP mode is used in encoding the current MB.

In Residue Prediction mode, the motion vector mvₑ is not necessarily equal to motion vector mv_{b} in actual coding.

Residue Prediction mode can also be combined with MI. In this case, the mode information from the base layer is used in accessing the pixel predictors in the enhancement layer, E0, then the reconstructed prediction residue in the base layer is used in predicting the prediction residue in the enhancement layer.

### SUMMARY OF THE INVENTION

It is a primary object of the present invention to further remove the redundancy existing among the SVC layers. This object can be achieved by improving the inter-layer prediction modes.

Improvements can be achieved by using MI even when the base layer MB is encoded in intra mode as follows:
Copy intra 4×4 mode of one 4×4 block in the base layer to multiple neighboring 4×4 blocks in the enhancement layer if the base layer resolution is lower than the enhancement layer resolution.
Use the intra 4×4 mode as intra 8×8 mode if the base layer resolution is lower than the enhancement layer resolution and the base layer resolution is half of the enhancement layer resolution in both dimensions

Improvements in the Residue Prediction (RP) can be achieved by:
Direct calculation of the base layer prediction residue used in RP;
Clipping of prediction residue for reducing memory requirement;
Tunneling of prediction residue in BLTP mode; and
Conditional coding of RP flag to save flag bits and reduce implementation complexity

Furthermore, tunneling of the mode information of the base layer can be carried out when the enhancement layer is coded in Base Layer Texture Prediction (BLTP) mode.

### BRIEF DESCRIPTION OF THE DRAWINGS

FIG. 1 shows the texture prediction modes in scalable video coding.

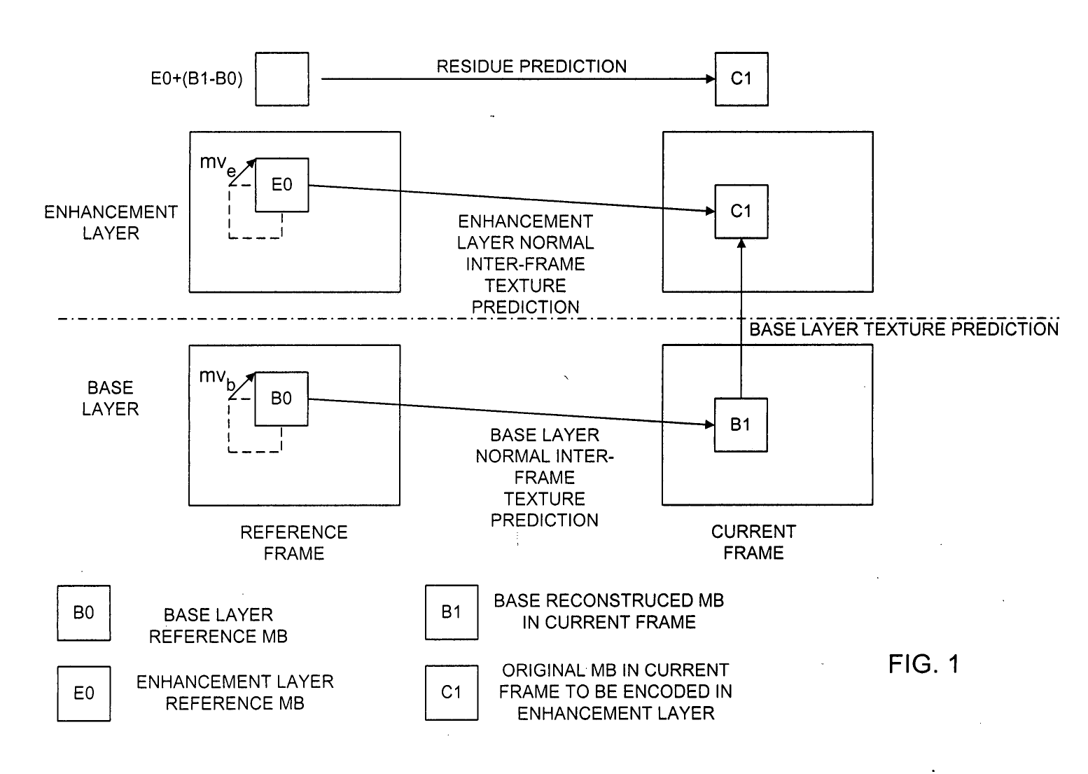

FIG. 2 illustrates the calculation of prediction residue used in residue prediction.

FIG. 3 shows the use of coded block pattern and intra modes from the spatial base layer.

FIG. 4 is a block diagram showing a layered scalable encoder in which embodiments of the present invention can be implemented.

### DETAILED DESCRIPTION OF THE INVENTION

The present invention improves the inter-layer prediction modes as follows:

Mode Inheritance from Base Layer when the Base Layer MB is Coded in Intra Mode

Normally MI is used for an MB in the enhancement layer only when the corresponding MB in the base layer is an inter-MB. According to the present invention, MI is also used when the base layer MB is an intra-MB. If the base layer resolution is the same as that of the enhancement layer, the modes are used as is. If the base layer resolution is not the same, the mode information is converted accordingly.

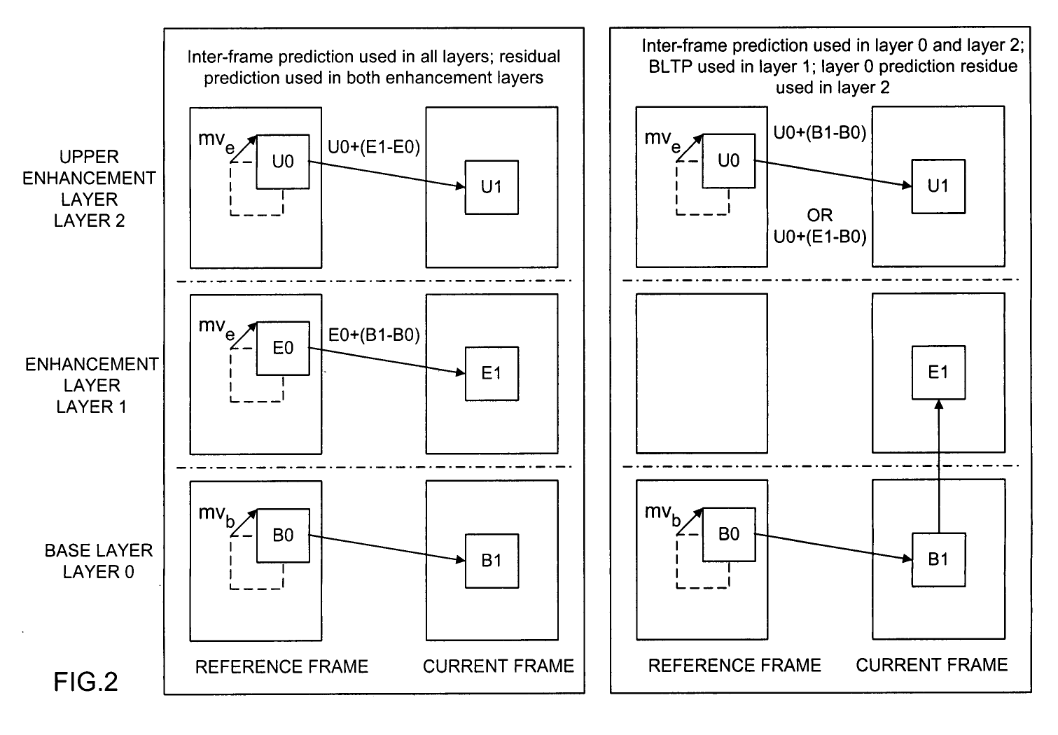

In H0.264, there are three intra prediction types: intra 4×4, intra 8×8, and intra 16×16. If the base layer resolution is lower than the enhancement resolution, the intra 4×4 mode of one 4×4 block in the base layer can be applied to multiple 4×4 blocks in the enhancement layer, if the luma signal of the base layer MB is coded in intra 4×4 mode. For example, if the base layer resolution is half of the enhancement layer resolution in both dimensions, the intra prediction mode of one 4×4 block in the base layer could be used by four 4×4 blocks in the enhancement layer, as illustrated at the right side of FIG. 2.

In another embodiment, if the base layer resolution is half of that of the enhancement layer and the luma signal of the base layer MB is coded in one intra 4×4 mode, then the intra 4×4 mode of a 4×4 block in the base layer is used as an intra 8×8 mode for the corresponding 8×8 block in the enhancement layer. That is because the intra 8×8 modes are defined similarly as the intra 4×4 modes in terms of prediction directions. If the intra 8×8 prediction is applied in the base layer, intra 8×8 prediction mode of one 8×8 block in the base layer is applied to all four 8×8 blocks in the MB in the enhancement layer.

The intra 16×16 mode and the chroma prediction mode can always be used as is even when the resolution of the base layer is not the same as that of the enhancement layer.

Tunneling of the Mode Information in Base Layer Texture Prediction Mode

In prior art, no mode decision information from layer N−1 is needed in coding the MB at layer N, if this MB is predicted from the layer N−1 in the BLTP mode. According to the present invention, all the mode decision information of the MB at layer N−1 is inherited by the MB at layer N, and the information could be used in coding the MB(s) at layer N+1, although the information may not be used in coding the MBs at layer N.

Residue Prediction (RP)

Direct Calculation of the Base Layer Prediction Residue used in RP

The value used for Residue Prediction in coding an MB at layer N should be “true residue” at layer N−1, which is defined as the difference between the reconstructed co-located block at layer N−1 and the non-residue-adjusted predictor of this co-located block at layer N−1, given the corresponding MB at layer N−1 is inter-coded.

In the decoding process, a “nominal residue” can be calculated using the following 2 steps:

1. Dequantize the quantized coefficients, and

2. Perform inverse transform on the dequantized coefficients.

mode of one 4×4 block in the base layer could be used by four 4×4 blocks in the enhancement layer, as illustrated at the right side of FIG. 2.

If Residue Prediction is not used in coding an MB at this layer, then for this MB at this layer the nominal residue is the same as the true residue. If Residue Prediction is used in coding an MB at this layer, the nominal residue is different from the true residue because the nominal residue is the difference between the reconstructed pixel and the residue-adjusted predictor.

Take a 3-layer SVC structure at the left side of FIG. 2 as an example. If Residue Prediction is not used for the MB at layer 0, then both the nominal residue and true residue are (B1−B0). However, if Residue Prediction is used for the MB at layer 1, then the nominal residue is (E1−(E0+(B1−B0))). The result can be directly obtained from dequantization and inverse transform of the dequantized coefficients. The true residue is (E1×E0).

Following are two exemplary methods for calculating the true residue at layer N−1, which will be used in residue prediction at layer N:

Method A

Perform full reconstruction on both the current frame and its reference frames at layer N−1, then the true residue at layer N−1 can be easily calculated. However, for some applications it is desirable that reconstruction of a frame at layer 2 does not require the full reconstruction of the frame at layer 0 and layer 1.

Method B

If Residue Prediction is not used for the MB at layer N−1, then the true residue at layer N−1 is the same as the nominal residue. Otherwise it is the sum of the nominal residue at layer N−1 and true residue at layer N−2.

In FIG. 2, true residue at the layer 0 is (B1−B0) and the RP mode is used in coding the corresponding MB at layer 1. The residue-adjusted predictor for the current MB at layer 1 is (E0+(B1−B0)). The reconstructed nominal prediction residue at layer 1 is (E1−(E0+(B1−B0)). Accordingly, the true residue at layer 1 can be calculated as
(E1−(E0+(B1−B0))+(B1−B0)=(E1−E0)
Method B does not need full reconstruction of the frame at lower layers. This method is referred to as the “Direct calculation” of true residue.

Mathematically the results from Method A and Method B are the same. In actual implementation, however, the results could be slightly different because of the various clipping operations performed. According to the present invention, the following are procedures for calculating “true residue” at layer N−1, which is to be used in residue prediction at layer N:
1. Dequantize the quantized coefficients;
2. Perform inverse transform on the dequantized coefficients to obtain “nominalResidue at layer N−1”;
3. If Residue Prediction is not used for the MB in layer N−1, set “tempResidue” to be equal to “nominalResidue at layer N−1”, then go to step 5;
4. If Residue Prediction is used for the MB in layer N−1, set “tempResidue” to be equal to “nominalResidue at N−1”+“trueResidue at layer N−2”, then go to step 5;
5. Perform clipping on “tempResidue” to obtain “trueResidue” at layer N−1”.

In the present invention, true residue has been clipped so it will fall within a certain range to save the memory needed for storing the residue data. Additional syntax element “residueRange” in the bitstream can be introduced to indicate the dynamic range of the residue. One example is to clip the residue in the range [−128, 127] for 8-bit video data. More aggressive clipping could be applied for certain complexity and coding efficiency trade-off.

Residue Prediction in Coefficient Domain

In one embodiment, Residue Prediction can be performed in the coefficient domain. If the residual prediction mode is used, the base layer prediction residue in coefficient domain can be subtracted from the transform coefficients of prediction residue in the enhancement layer. This operation is then followed by the quantization process in the enhancement layer. By performing Residue Prediction in coefficient domain, the inverse transform step in reconstructing the prediction residue in the spatial domain in all the base layers can be avoided. As a result, the computation complexity can be significantly reduced.

Tunneling of Prediction Residue in Intra and BLTP Mode

Normally, the prediction residue is set to 0 if the MB in the immediate base layer is either an intra-MB or it is predicted from its own base layer by using BLTP mode. According to the present invention, the prediction residue will be transmitted to the upper enhancement layer, but no residue from intra-frame prediction will be added. Considering a 3-layer SVC structure: If an MB is coded in inter-mode in layer 0, and intra mode in layer 1, the prediction residue of layer 0 can be used in layer 2.

If the MB in the current enhancement layer (for example, layer 1 in FIG. 2) is coded in BLTP mode, in one embodiment, the prediction residue of its base layer (layer 0), of value (B1−B0), will be recorded as layer 1 prediction residue and used in the residue prediction of the upper enhancement layer (layer 2). The nominal residue from BLTP mode in layer 1 is not added. This is similar to the intra-mode discussed above. In another embodiment, the BLTP mode prediction residue of value (E1−B1) in the layer 1 is also added to the base layer prediction residue (B1−B0). As such, the residue used in layer 2 residue prediction is (E1−B0) rather than (B1−B0). This is shown on the right side of FIG. 2.

Conditional Coding of RP Flag to Save Flag Bits and Reduce Implementation Complexity

RP flag is used to indicate whether RP mode is used for an MB in the enhancement layer. If the reconstructed prediction residue that can be used in Residue Prediction for an MB in the enhancement layer is zero, the residue prediction mode will not help in improving the coding efficiency. According to the present invention, at the encoder side, this condition is always checked before Residue Prediction mode is evaluated. As such, a significant amount of computation can be reduced in mode decision. In both the encoder side and the decoder side, no RP flag is coded if the reconstructed prediction residue that can be used in Residue Prediction for an MB in the enhancement layer is zero. As such, the number of bits spent on coding the RP flag is reduced.

In coding a macroblock, one or more variables are coded in the bitstream to indicate whether the MB is intra-coded or inter-coded, or coded in BLTP mode. Here collectively variable mbType is used for differentiating these three prediction types.

The nominal prediction residue is always 0 for an intra-coded macroblock. If none of the collocated macroblocks in the base layers are inter-coded, the reconstructed prediction residue that can be used in Residue Prediction for an MB in the enhancement layer is 0. For example, in a 2-layer SVC structure, if the base layer is not inter-coded, the residue that can be used in coding the macroblock in layer 1 is 0, then the residue prediction process can be omitted for this macroblock, and no residue prediction flag is sent.

In video coding, it is common to use Coded Block Pattern (CBP) to indicate how the prediction residue is distributed in MB. A CBP of value 0 indicates that the prediction residue is 0.

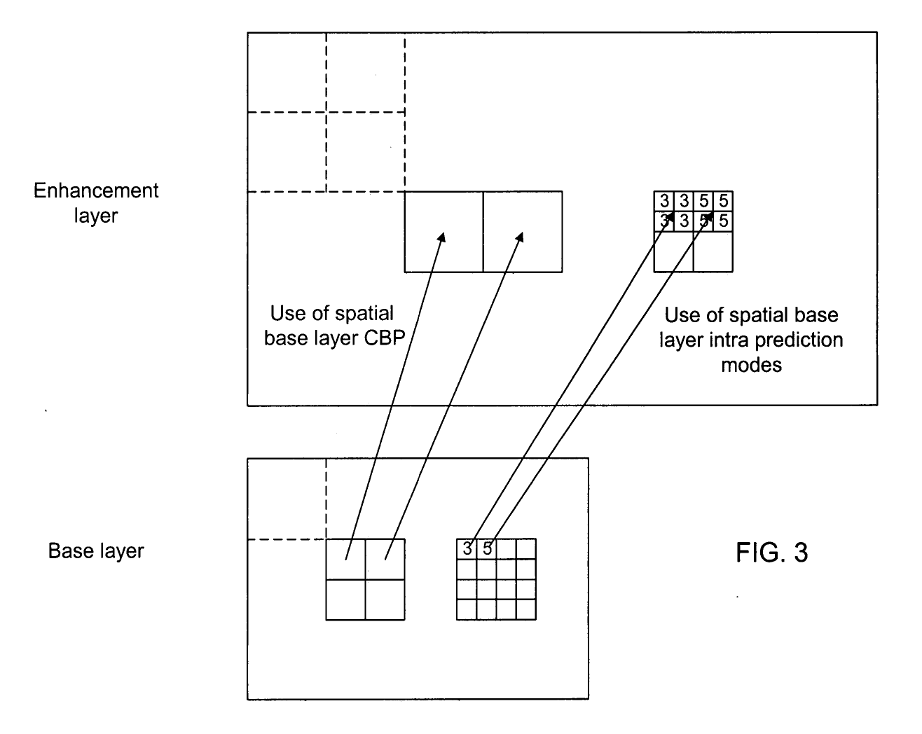

When the base layer is of a different resolution, CBP in the base layer is converted to the proper scale of the enhancement layer, as shown in FIG. 3. A particular example is that the base resolution is half of that of the enhancement layer in both dimensions. Normally a CBP bit is sent for each 8×8 luma block in an MB. By checking one CBP bit at proper position, it is possible to know whether the prediction residue from a spatial base layer is 0. This is explained at the left side of FIG. 3. Chroma CBP can also be checked in a similar manner in order to determine whether Residual Prediction should be use.

In one embodiment of the present invention, CBP and mbType of the base layers could be used to infer whether the prediction residue that can be used in Residue Prediction of the current MB is 0. As such, actually checking the prediction residue in the MB pixel-by-pixel can be avoided.

It should be understood that the result from checking CBP and mbType may not be identical to the result from checking the prediction residue pixel-by-pixel, because some additional processing steps may be applied on the base layer texture data after it is decoded, such as the upsampling operations if the base layer resolution is lower than that of the enhancement layer and loop filtering operations. For example, if the resolution of the base layer is half of that of the enhancement layer, the reconstructed prediction residue of the base layer will be upsampled by a factor of 2 (see FIG. 3). The filtering operations performed in upsampling process could leak a small amount of energy from a nonzero block to a neighboring zero block. If the prediction residue of a block is checked pixel-by-pixel, we may find the residue is nonzero, although the information inferred from CBP and mbType is 0.

Thus, by checking only the CBP and mbType values in base layers, the computation complexity as well as memory access can be reduced.

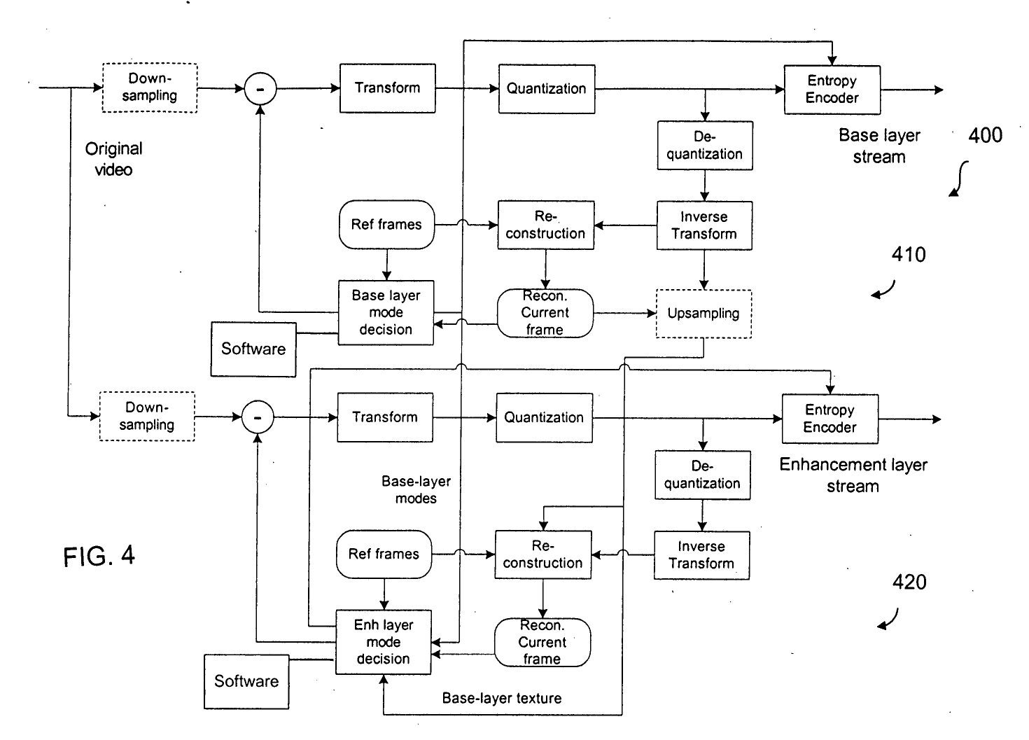

FIG. 4 shows a block diagram of a scalable video encoder 400 in which embodiments of the present invention can be implemented. As shown in FIG. 4, the encoder has two coding modules 410 and 420 each of the modules has an entropy encoder to produce a bitstream of a different layer. It is understood that the encoder 400 comprises a software program for determining how a coefficient is coded. For example, the software program comprises a pseudo code for using MI even when the base layer MB is encoded in intra code by copying intra 4×4 mode of one 4×4 block in the base layer to multiple neighboring 4×4 blocks in the enhancement layer and by using the intra 4×4 mode as intra 8×8 mode if the base layer resolution is only half that of the enhancement layer. The software program can be used to calculate the base layer prediction residue directly using Residue Prediction Mode and to clip the prediction residue.

In sum, intra 8×8 and intra 4×4 are different luma prediction types. The basic idea in intra prediction is to use the edge pixels in the neighboring block (that are already processed and reconstructed) to perform directional prediction of the pixels in the block being processed. A particular mode specifies a prediction direction, such as down-right direction, or horizontal direction, and so on. Yet more details on that, in horizontal direction, the edge pixels at the left side of the current block will be duplicated horizontally, and used as the predictors of the current block.

In intra 8×8 prediction type, MB is processed in 4 8×8 blocks, and there is one intra 8×8 prediction mode associated with each 8×8 block. In intra 4×4, the MB is processed in 4×4 blocks. However, the mode (prediction direction) is defined similarly for both prediction types. So in one type of implementation, we could copy the prediction mode of one 4×4 block to 4 4×4 blocks in the enhancement layer if the frame size is doubled in both dimensions. In another type of implementation, we could use the prediction mode of one 4×4 block as the intra 8×8 mode of one 8×8 block in the enhancement layer for the same 2/1 frame size relationship.

In the present invention, half resolution is for both directions. But in some applications, the video may be down-sampled only in one dimension. If this is the case, we just copy one intra 4×4 mode to 2 4×4 blocks in the enhancement layer, and the intra 4×4 to intra 8×8 mapping will no longer be valid.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in scalable video coding for reducing redundancy existing in scalable video layers, the layers comprising a base layer and at least one enhancement layer, each layer comprising at least one macroblock, said method comprising:
determining whether to use a residue prediction mode in coding a macroblock in the enhancement layer; and
if the residue prediction mode is used, coding a residual prediction flag into the enhancement layer bit stream, said flag indicating whether residual prediction is applied to the macroblock in the enhancement layer; and
if the residue prediction mode is not used, omitting the residual prediction flag from the enhancement layer bit stream for said macroblock.

2. The method of claim 1, wherein said determining is based on whether base layer residual is zero.

3. The method of claim 1, wherein said determining is based on a manner in which the macroblock in the base layer is coded.

4. The method of claim 1, wherein the determination is based on the type of collocated macroblocks in the base layer

5. The method of claim 3, wherein the residue prediction mode is not used if none of the collocated macroblocks in the base layer are inter-coded.

6. The method of claim 1, wherein the residue prediction mode is not used if a coded block pattern for the base layer macroblock is zero

7. The method of claim 6, wherein the base layer and at least one enhancement layer are of different spatial resolutions, and wherein the residue prediction mode is not used if a bit from the base layer coded block pattern is set to zero, said bit corresponding to a macroblock that would be collocated with the particular enhancement layer macroblock if upsampling of the base layer were to occur.

8. The method of claim 1, wherein the additional step of computing mode inheritance either precedes or follows said determination.

9. The method of claim 8, wherein the base layer and enhancement layer have equal spatial resolution, and wherein the mode of the particular macroblock in the enhancement layer is inherited from the collocated base layer macroblock, and the collocated base layer macroblock is an intra-macroblock.

10. The method of claim 8, wherein the enhancement layer has a larger spatial resolution than the base layer, and wherein the mode of an intra-macroblock in the base layer is inherited from a base layer macroblock which, if upsampled, would encompass the particular enhancement layer macroblock.

11. A scalable video encoder for coding for reducing redundancy existing in scalable video layers, the layers comprising a base layer and at least one enhancement layer, each layer comprising at least one macroblock, said encoder comprising:
means for determining whether to use a residue prediction mode in coding a macroblock in the enhancement layer; and
means for coding a residual prediction flag into the enhancement layer bit stream if the residue prediction mode is used, said flag indicating whether residual prediction is applied to the macroblock in the enhancement layer; and
if the residue prediction mode is not used, omitting the residual prediction flag from the enhancement layer bit stream for said macroblock.

12. The encoder of claim 11, wherein said determining is based on whether base layer residual is zero.

13. The encoder of claim 11, wherein said determining is based on a manner in which the macroblock in the base layer is coded.

14. The encoder of claim 11, wherein the determination is based on the type of collocated macroblocks in the base layer

15. The encoder of claim 13, wherein the residue prediction mode is not used if none of the collocated macroblocks in the base layer are inter-coded.

16. The encoder of claim 11, wherein the residue prediction mode is not used if a coded block pattern for the base layer macroblock is zero

17. The encoder of claim 16, wherein the base layer and at least one enhancement layer are of different spatial resolutions, and wherein the residue prediction mode is not used if a bit from the base layer coded block pattern is set to zero, said bit corresponding to a macroblock that would be collocated with the particular enhancement layer macroblock if upsampling of the base layer were to occur.

18. A software application product comprising a storage medium having a software application for use in scalable video coding for reducing redundancy existing in scalable video layers, the layers comprising a base layer and at least one enhancement layer, each layer comprising at least one macroblock, said software application comprising program codes for carrying out the method steps of claim 1.
